(19) United States
(12) Patent Application Publication
(10) Pub. No.: US 2008/0075423 A1
(43) Pub. Date: Mar. 27, 2008

(54) AUTOMATIC RESOLUTION OF VIEWING AND RECORDING CONFLICTS IN DIGITAL VIDEO RECORDERS

(76) Inventor: Tod A. DeBie, Costa Mesa, CA (US)

Correspondence Address: TOD DEBIE, 2190 PLACENTIA AVE., # C, COSTA MESA, CA, 92627, US

(21) Appl. No.: 11/535,075

(22) Filed: Sep. 26, 2006

(51) Int. Cl. H04N 5/91

(52) U.S. Cl. 386/83

(57) ABSTRACT

A method of resolving program recording conflicts arising from an attempt to change the channel where there are not enough tuners to service all desired viewing and recording activities, comprising: searching a program guide for scheduled future broadcasts of the plurality of conflicted programs, selecting a plurality of future broadcasts of the conflicted programs at times and channels where all conflicts are resolved to the greatest extent possible by searching for the future broadcasts of the plurality of conflicted programs and selecting the times and channels where the highest number of selected programs will be able to be recorded by the available tuners, and scheduling a recording for each of the selected programs based on the selected recording times and channels.

### BACKGROUND OF THE INVENTION

1. Field of Invention

This invention generally relates to recording television programs, specifically to resolving recording and viewing conflicts to enable the maximum number of desired program recordings to occur.

2. Background of the Invention

Recording systems for television programs such as digital video recorders allow users to easily record selected programs. Digital video recorders typically include a tuner so that the broadcast of a desired program may be singled out and viewed or recorded, a storage medium where the system stored the program for later viewing and a user interface to enable the user to control what programs are recorded and what programs are viewed. They may also include a program guide, which shows what programs are on what channels at what times to enable the user to easily select a desired program for viewing or recording. Such systems may be entirely self contained, such as in a set top box, or they have multiple separate parts, such as separate tuners and storage mediums, such as in software based systems intended to run on one or more computers with storage and tuners, etc. Such systems have one or more tuners and the number of programs they can record simultaneously are limited to the number of tuners in the system such that a system with two tuners would allow any of the following: the user can watch one live program, the user can watch one live program and record another, or the user can record two programs but cannot watch a live program other than the two being recorded. Some systems will allow the user to watch a pre-recorded program while all of the tuners are busy recording live programs.

A common issue encountered by people in the course of using a digital video recorder is a recording conflict. A recording conflict occurs when there are not enough tuners available to record all desired programs. A recording conflict also occurs when there are not enough tuners available to record all desired programs while servicing a live program viewing request from the user.

For example, if a two tuner digital video recorder is currently recording two programs and the user wants to either record or watch a third program, a recording conflict arises because there are not enough tuners available to service all the requests.

When a recording conflict occurs in existing systems, they typically give the user the option to either keep the current recording(s) going or to abandon one of them in favor of the new recording or viewing selection. If the user wants to record or view all of the programs, they will have to manually search for other times when the programs are on and manually set them to record or watch them live to resolve the conflict. This is undesirable and may cause the loss of recorded information as well as inconveniencing a potential end user. There remains a need in the art for systems and methods to resolve these and other recording conflicts in a more efficient and cost effective manner.

### SUMMARY

Accordingly, several advantages are provided, according to one or more embodiments, which may include relieving users of the burden of manually resolving recording and viewing conflicts to the maximum extent possible by automatically searching for different times when the currently conflicted programs are broadcast un-conflicted and automatically setting the programs to record at the alternate un-conflicted times.

According to one or more embodiments, an additional advantage may include relieving users of the burden of manually searching for future broadcasts of programs they want to view or record that are currently in progress if they want to get the entire program recorded by automatically searching for future un-conflicted broadcasts of programs where the viewing or recording is started while the program is in progress and giving users the option of the future recording to get the complete program.

According to one embodiment, a method of resolving program recording conflicts arising from an attempt to change the channel where there are not enough tuners to service all desired viewing and recording activities by searching the program guide for future broadcasts of the conflicted programs and selecting found broadcasts for recording where the highest number of selected programs will be able to be recorded by the available tuners.

According to another embodiment, a method of recording the entirety of a program that is selected to be recorded while it is in-progress by searching the program guide for a future broadcast of the program and recording the future broadcast.

According to one embodiment, a method of storing unresolved conflicts so that they may be searched for and recorded in the future. If a program is un-recordable due to conflicts, and all conflict resolution methods have failed, the program will be searched for at a later date to see if a future broadcast may be found and recorded.

Further advantages will become apparent from a consideration of the drawings and ensuing description.

### BRIEF DESCRIPTION OF DRAWINGS

Aspects of this disclosure are illustrated by way of example, and not by way of limitation, in the accompanying drawings, wherein:

FIG. 1 depicts conflict resolution when a user attempts to change the channel and there are no tuners are currently available, in accordance with an embodiment of the present invention.

FIG. 2 depicts conflict resolution when the digital video recorder attempts to change the channel to record a scheduled program, in accordance with an embodiment of the present invention.

FIG. 3 depicts conflict resolution by setting a future broadcast of a program to record when a user tries to record said program and it is already in progress, in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

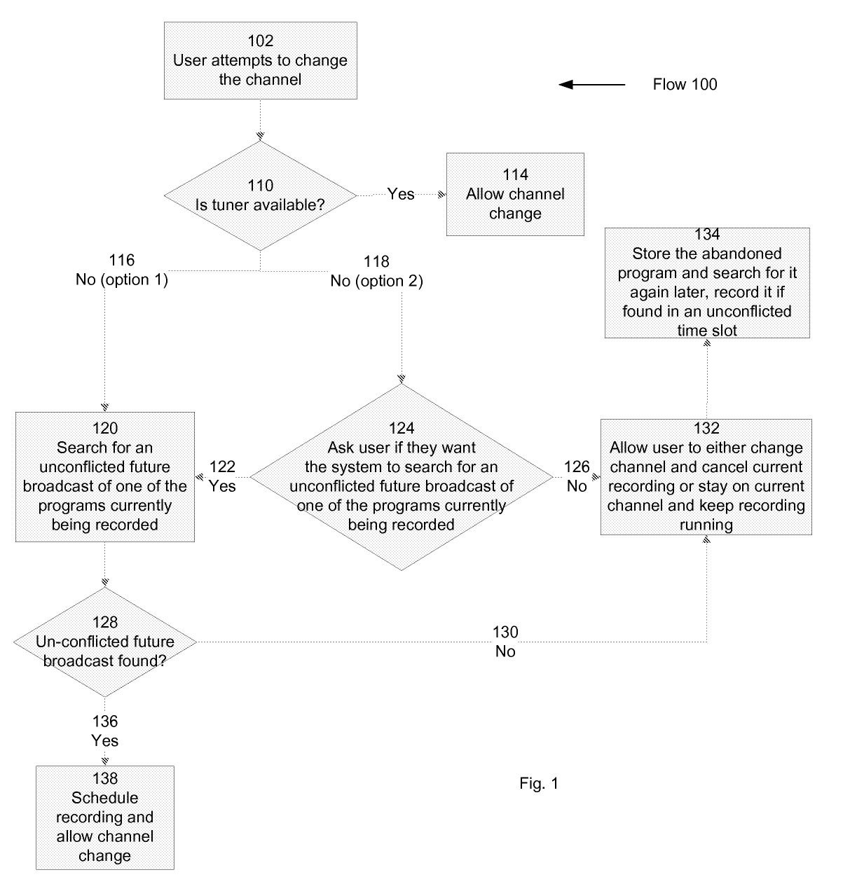

FIG. 1 depicts a flowchart of an exemplary method for managing recording conflicts when the user attempts to change the channel on a digital video recorder, in accordance with an embodiment of the present invention. In reference to FIG. 1, an exemplary recording management flow 100 may comprise one or more operations and may include the user attempting to change the channel on a digital video recorder in operation 102.

In operation 110, the digital video recorder checks to see if a tuner is available. Tuners are considered available if they are not currently being used to record a program. A recorder having multiple tuners will not be available if all tuners are currently recording programs. For example, the digital video recorder may have two tuners, both of which are busy recording separate programs. The user may currently be watching one of the programs currently recording or another pre-recorded program. The user then tries to change to a channel other than the channels of the two programs currently being recorded. Since the two tuners are busy recording, a recording conflict arises. If a tuner is available, the digital video recorder allows the channel change in operation 114.

Operations 116 and 118 may include two configurable options presented to a user. In some embodiments, a user may configure the recorder to do one or the other. In other embodiments, only one option may be used.

If in operation 110 a tuner is not available, in operation 116, if so configured, the system may go to operation 120 where a search the program guide to see if a future recording is available where there are no other recording conflicts. If initially there are no un-conflicted slots available, the system may then check the program listings to see if programs currently set to record in the future conflicted slots can be moved to other unconflicted slots. The system may iterate through this process to attempt to resolve all conflicts.

If a tuner is not available, in operation 118, if so configured, the system may go to operation 124 where it may prompt the user to decide if they want the system to search for an un-conflicted future broadcast of one of the programs currently recording. If the user does not want the system to do the search, it may go to operation 132, described below. If the user wants to do the search, it may go to operation 120, described above.

In operation 128, if the conflict cannot be resolved in operation 120, the system may go to operation 132 where it may prompt the user to either abandon one of the current recordings to free up a tuner so they can change the channel, or keep the current recordings running and stay on the current channel which may be one of the programs currently being recorded.

The system can be configured to stop at operation 132 or through a user controlled configuration option, it can continue to operation 134 where it may store the program that was abandoned in operation 132 and attempt to search for it later. Through user configuration options, the system may always store the program and search for it later, never store it or search for it later, or it may ask the user each time if they want to store it and search for it later.

If the program is subsequently found the system may record it provided it can be found in an unconflicted timeslot or if the programs already set during to record during conflicted timeslots can be moved by iterating through the process in operation 120.

In operation 128, if the conflict was resolved in operation 120, the system may go to operation 138 where it may schedule the future unconflicted recording of the program recording that may currently be abandoned so that the channel may be changed per the user's wishes. The system may optionally save the already recorded portion of the program currently recording that is being abandoned in favor of a future recording date and then only record the parts that have not been recorded to minimize future usage of the tuners to enable the recording of other programs.

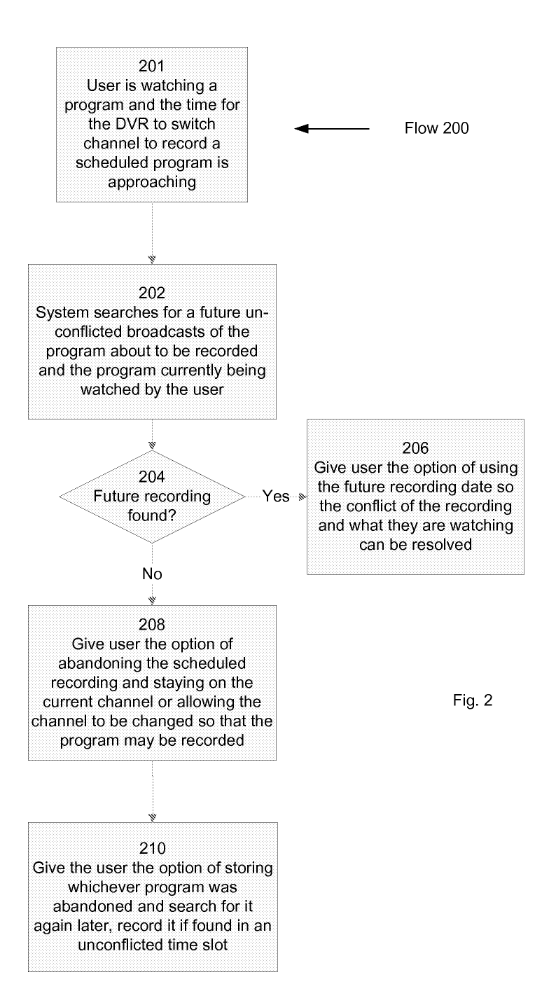

FIG. 2 depicts a flowchart of an exemplary method for managing recording and viewing conflicts when the user is watching a live program and the system needs the tuner that the user is currently using to record another program that is about to start. In reference to FIG. 2, an exemplary flow 200 according to an embodiment of the present invention may comprise one or more operations that include the user attempting to change the channel on a digital video recorder in operation 201.

In operation 201, the user is watching a live program while the time for a scheduled program recording on another channel is approaching and there are no free tuners to allow the user to both continue watching the program on current channel and record the upcoming program on the alternate channel.

In operation 202, the system searches for future un-conflicted broadcasts of the program about to be recorded, the program currently being watched by the user and any programs that are currently being recorded. If initially there are no un-conflicted slots available, the system may then check the program listings to see if programs currently set to record in the future conflicted slots can be moved to other unconflicted slots. The system may iterate through this process to attempt to resolve all conflicts.

In operation 204, if the future un-conflicted recording(s) were found, it may go to operation 206 where the system may give the user the option of selecting one of the future recordings of the scheduled program(s) or the program they are watching live to resolve the conflict.

In operation 204, if the conflicts were not resolved, it may go to operation 208 where the system may give the user the option of abandoning the scheduled recording and staying on the current channel, or allowing the channel to be changed to that the scheduled program may be recorded. The system may then go to operation 210 where it may store the program that was abandoned in operation 208 and attempt to search for it later. Through user configuration options, the system may always store the program and search for it later, never store it or search for it later, or it may ask the user each time if they want to store it and search for it later.

If the program is subsequently found the system may record it provided it can be found in an unconflicted timeslot or if the programs already set during to record during conflicted timeslots can be moved by iterating through operation 202.

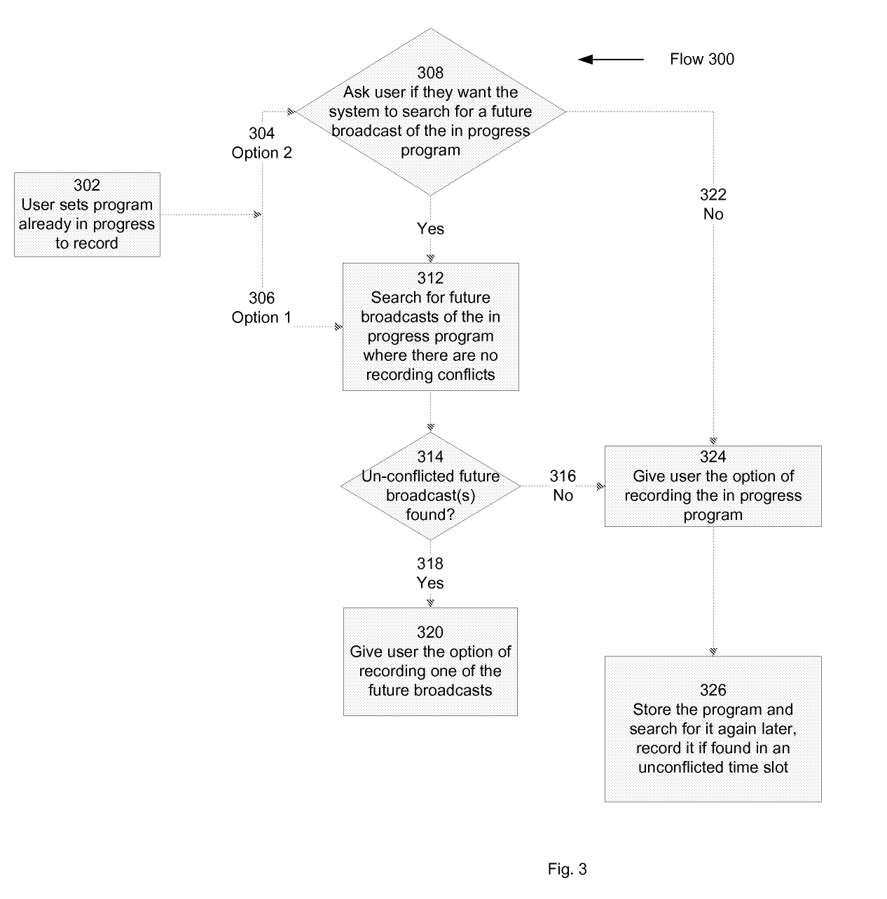

FIG. 3 depicts a flowchart of an exemplary method for getting a complete recording of a program when a user starts recording on a program already in progress. In reference to FIG. 3, an exemplary flow 300 according to an embodiment of the present invention may comprise one or more operations that include the user attempting to change the channel on a digital video recorder in operation 301.

In operation 301, a user sets a program already in progress to record. The start of the program is not immediately available in a buffer or otherwise.

From operation 301 the system may go to either operation 304 or 306 depending on how the system is configured. In the preferred embodiment, users can configure the system to do one or the other. In other embodiments, only one of the options is used.

In operation 304 the system may go to operation 308 where it may prompt the user to decide if they want the system to search for an un-conflicted future broadcast of the in-progress program. If the user does not want the system to do the search, it may go to operation 324, described below. If the user wants to do the search, it may go to operation 312.

In operation 306, the user may not be prompted if they want a search for a future broadcast to be searched for. The system may go to operation 312.

In operation 312, the system may conduct a search of the available program listings that tell what shows are on what channel when for the in-progress program to see if a future recording is available where there are no other recording conflicts. If initially there are no un-conflicted slots available, the system may then check the program listings to see if programs currently set to record in the future conflicted slots can be moved to other unconflicted slots. The system may iterate through this process to attempt to resolve all conflicts.

In operation 314, if an un-conflicted future broadcast is found in operation 312, the system may go to operation 320 where it may give the user the option of recording a future broadcast of the program currently in progress.

In operation 314, if an un-conflicted future broadcast is found in operation 312, the system may go to operation 324 where it may give the user the option of recording the program in-progress from the current point in the program.

In operation 326, the system may store the program that was not found in operation 314 and attempt to search for it later. Through user configuration options, the system may always store the program and search for it later, never store it or search for it later, or it may ask the user each time if they want to store it and search for it later.

If the program is subsequently found the system may record it provided it can be found in an unconflicted timeslot or if the programs already set during to record during conflicted timeslots can be moved by iterating through operation 312.

Although the invention has been described with respect to particular embodiments, this description is only an example of the invention's application and should not be taken as a limitation. It should also be understood that numerous modifications, combinations and variations are possible in accordance with the principles of the present invention. Accordingly, the scope of the invention is defined only by the following claims.

I claim:

1. A method of resolving program recording conflicts arising from an attempt to change the channel where there are not enough tuners to service all desired viewing and recording activities, comprising:
searching a program guide for scheduled future broadcasts of the plurality of conflicted programs;
selecting a plurality of future broadcasts of the conflicted programs at times and channels where all conflicts are resolved to the greatest extent possible by searching for the future broadcasts of the plurality of conflicted programs and selecting the times and channels where the highest number of selected programs will be able to be recorded by the available tuners; and
scheduling a recording for each of the selected programs based on the selected recording times and channels.

2. The method of claim 1, wherein the method is conducted within a digital video recorder.

3. The method of claim 1, further comprising:
enabling the user to control if they want the program guide search for the scheduled future broadcasts of the conflicted programs to be conducted.

4. The method of claim 1, further comprising:
enabling the user to select a future broadcast from the results of the search, if any, to be recorded.

5. A method of recording the entirety of a program that is selected to be recorded while it is in-progress, comprising:
searching the program guide for future scheduled broadcasts of the in-progress program;
selecting the future broadcast of the in-progress program from the search, if any; and
scheduling the selected future broadcast of the in-progress program, if found, to be recorded.

6. The method of claim 5, wherein the method is conducted within a digital video recorder.

7. The method of claim 5, further comprising:
enabling the user to select the future broadcast from the results of the search, if any, to be recorded

8. The method of claim 5, further comprising:
enabling the user to control if they want the searches for future broadcasts to be conducted.

9. The method of claim 5, further comprising:
evaluating if any of the future broadcasts of the programs in the search results, if any, do not conflict with other scheduled recordings such that there will not be enough tuners available to service the requests;
resolving each resulting recording conflict to the greatest extent possible by searching for future broadcasts of the plurality of conflicted programs and selecting the times and channels where the most programs will be able to be recorded by the available tuners; and
scheduling a recording for each of the selected programs based on the selected broadcast times and channels.

10. A method of storing unresolved recording conflicts so that they may be searched for and recorded in the future:
storing any program where the program recording is abandoned due to an unresolved schedule conflict; and

11. The method of claim 10, wherein the method is conducted within a digital video recorder.

12. The method of claim 10, further comprising:
searching for future a broadcast of the stored programs after a period of time has elapsed;
selecting a future broadcast from the results, if any, of the search; and
scheduling the future broadcast of the stored program, if found, to be recorded.

13. The method of claim 10, further comprising:
searching for future broadcast of said stored programs upon user demand;
selecting a future broadcast from the results, if any, of the search; and
scheduling said future broadcast of the stored program, if found, to be recorded.
